(19) United States
(12) Patent Application Publication
(10) Pub. No.: US 2004/0051676 A1
(43) Pub. Date: Mar. 18, 2004

(54) Signal cross polarization system and method

(76) Inventors: Edward C. Travis, Park City, UT (US); John R. James, Concord, NC (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/651,116

(22) Filed: Aug. 28, 2003

Related U.S. Application Data
(60) Provisional application No. 60/407,164, filed on Aug. 30, 2002.

(51) Int. Cl. H01Q 3/00

(52) U.S. Cl. 343/760

(57) ABSTRACT

The present invention expedites cross polarization of a polarized signal from a transmitter such as a satellite. According to one method, an antenna is oriented to point to a first window to communicate with a first satellite. The antenna is peaked to find a first vector for maximum signal strength. The antenna is then oriented to point to a second window to communicate with a second satellite, and peaked to find a second vector for maximum signal strength. The first and second vectors are manipulated to obtain a third vector extending between the first and second satellites, and the appropriate skew angle for cross polarization of the antenna is derived from the third vector. Alternatively, the antenna may have two LNB's to permit peaking of the first and second satellites simultaneously. When both satellites are peaked, the antenna will automatically be disposed at the proper skew angle for cross polarization.

### 1. RELATED U.S. APPLICATIONS

This application claims the benefit of U.S. Provisional Patent Application Serial No. 60/407,164, filed Aug. 30, 2002 and entitled PROCESS OF CROSS POLARIZING A LINEAR POLARIZED SATELLITE SIGNAL USING AN ADJACENT SATELLITE SIGNAL, which is incorporated herein by reference.

### BACKGROUND OF THE INVENTION

1. Field of the Invention

The present invention relates to wireless communication. More specifically, the present invention relates to a system and method for cross polarizing a linear polarized satellite signal to facilitate communication between a satellite and a ground-based antenna.

2. Description of Related Art

Wireless communication is a continuously expanding field that removes many barriers to communication. Most notably, the communicating parties need not be physically connected together via wires or the like; rather, one or both communicating parties may move relatively freely. Satellites have been especially important for providing information and services such as global position data, television programs, and Internet access.

Many such satellites are in geostationary orbit at an elevation of about 22, 500 miles above the Equator. Satellites in geostationary orbit travel around the Earth at a rate of one cycle per day, and thus remain substantially stationary with respect to their longitudinal positions over the Equator. The orbit followed by geostationary satellites is often called the “Clarke Belt.” The satellites generally have antennas in the form of dishes physically oriented along lines generally tangent to the Clarke Belt so that the dishes transmit signals directly toward the Earth. Generally, ground-based antennas are disposed parallel to their satellite-mounted counterparts in order to permit the antennas to communicate with each other via microwave signals. A ground-based antenna may be rotated about an elevation axis and an azimuth axis to bring the ground-based antenna to an orientation parallel to that of the satellite antenna.

Many satellites transmit and/or receive a linear polarized signal. A polarized signal is generally transmitted along two orthogonal planes, so that the satellite is able to transmit at a bandwidth twice as large as would otherwise be available. In order to properly and efficiently receive such signals, a ground-based antenna must not only be oriented parallel to the satellite antenna via the azimuth and elevation axes, but the ground-based antenna must also be rotated about a skew axis orthogonal to the elevation and azimuth axes to rotationally align the ground-based antenna with the satellite antenna. The ground-based antenna is thus able to properly receive each part of the polarized signal. The process of aligning the ground-based antenna with the satellite antenna via rotation about the skew axis is termed “cross polarization.” Proper cross polarization is required by the FCC.

Unfortunately, determining the exact skew orientation of the satellite antenna can be rather difficult. Due to the gravitational pulls of the sun and the moon, as well as solar weather, satellite positioning must be periodically adjusted to maintain geostationary orbit. In order to conserve fuel, geostationary satellites typically make such adjustments in a manner that keeps them within a specified window, such as a square region seventy miles long and seventy miles wide. Thus, the exact position of the satellite may not be known when the earth-based antenna is set up. In addition to such positional variation, geostationary satellites are known to wobble in orbit by as much as three to four degrees.

Furthermore, a variety of other effects can distort or interfere with signals transmitted between the satellite and the ground-based antenna. For example, solar flares pass through the atmosphere and, in doing so, create magnetic fluctuations of the magnetosphere so intense that the magnetosphere becomes an elongated oval with a length-to-width ratio larger than three-to-one for over an hour. Such magnetic distortion can bend microwave signals. Furthermore, the ionosphere and troposphere have refractive properties that can cause temporary localized effects that are also capable of interfering with microwave signals.

The above-described factors make the skew axis orientation of a satellite antenna somewhat unpredictable. Hence, known cross polarization methods often involve trial and error. According to one known method, a ground-based antenna is first aligned parallel to the satellite antenna, and communication is attempted. A Satellite Operation Center in communication with the satellite provides feedback to the ground-based antenna to suggest adjustments to the skew orientation of the antenna based on known satellite, atmosphere, or magnetosphere conditions or based on analysis of the quality of the signal from the ground-based antenna. Further transmissions may be attempted and additional adjustments may be made accordingly.

The above-described procedure is disadvantageous in a number of respects. First, it is time consuming. Several hours may be required to cross polarize the ground-based antenna. This is particularly problematic for vehicle-mounted systems because each time the vehicle moves, the additional set-up time is required, during which the vehicle is unable to communicate. Furthermore, communication with the Satellite Operation Center is required. Such communication adds an additional point of failure to the satellite network and requires some of the network bandwidth to maintain cross polarization operations.

### SUMMARY OF THE INVENTION

The apparatus of the present invention has been developed in response to the present state of the art, and in particular, in response to the problems and needs in the art that have not yet been fully solved by currently available cross polarization systems and methods. Thus, it is an overall objective of the present invention to provide a signal cross polarization system and method that remedy the shortcomings of the prior art.

To achieve the foregoing objective, and in accordance with the invention as embodied and broadly described herein in the preferred embodiment, a network may include first and second satellites in geostationary orbit around the Earth, and a communication station. The first and second satellites are displaced from the center of the Earth by a first vector and a second vector, respectively.

The first and second vectors may not be initially available to the communication station; however, each of the first and second satellites has a drift area within which the satellite must be disposed, and these drift areas are available to the communication station. Each of the first and second satellites thus has a window, comprising a space extending from the Earth's center to the drift area, within which the corresponding vector must be disposed. Each of the first and second satellites has a tangent to the Clark Belt, which is the direction along which the corresponding satellite antenna (e.g., dish), is oriented.

The antenna of the communication station is to be disposed parallel to the antenna of the satellite with which it communicates. Hence, orientation of the antenna perpendicular to the first or second vectors orients the antenna for communication with the first or second satellites, respectively. Orientation of the antenna structure parallel to the corresponding first or second tangent provides the proper skew angle for cross polarization of the antenna of the communication station. Hence, if the communication station is to communicate with the first satellite, the antenna of the communication station should be oriented parallel to the first tangent for proper cross polarization. This refers to orientation of the antenna structure itself; not the direction along which signals are received by the antenna.

If the antenna is coupled to two LNB's (low noise, block down conversion devices), the antenna may be oriented parallel to the first tangent automatically by obtaining the first and second vectors. The LNB's are disposed such that the antenna can be oriented to simultaneously receive first and second signals from the first and second satellites, respectively. Thus, the antenna is first pointed at the first window via rotation of the antenna about the elevation and azimuth axes. The antenna is then moved until a peak signal is found. The orientation of the antenna that provides the peak signal within the first window is the first vector.

The antenna is then rotated about the skew axis until the antenna points at the second window. The antenna is further rotated about the skew axis until a peak signal is found. The peak signal within the second window is the second vector. The antenna is then aligned at the proper skew angle for cross polarization of the first signal from the first satellite.

Alternatively, if the antenna is only coupled to a single LNB, vector mathematics can be used to obtain the proper skew angle. The first tangent can be obtained by first obtaining the first and second vectors. The first and second vectors are obtained by pointing the antenna along the first and second windows, and moving the antenna until a peak signal is found. The vector along which the antenna points when the signal peaks within the first window is the first vector and the vector along which the antenna points when the signal peaks within the second window is the second vector. The first and second vectors are then processed, i.e., via vector subtraction or the like, to obtain a third vector extending between the first and second satellites.

The first vector is within the plane of the Clark Belt but is offset from the tangent to the first satellite by an angle. The angle is half the angle between the first and second vectors. Thus, the third vector can be offset by half the angle between the first and second vectors to obtain the first tangent. The skew angle is then provided by the third tangent.

The above-described methods may be carried out through the use of computer code stored within a control unit of the communication station. The control unit may be coupled to an LNB (and a second LNB, if one is present), a computer, a sensor array attached to the antenna, and a motor array disposed to rotate the antenna about the elevation, azimuth, and skew axes. Thus, the control unit can be initiated and/or controlled via the computer, assess signal strength from one or both LNB's, receive position and orientation data, and provide motor control signals. The control unit may accordingly have components such as an RF receiver/ADC (analog-to-digital converter), NIC (network interface card), sensor signal receiver/ADC, processor, memory, and motor controller/DAC (digital-to-analog converter). The components may be digitally linked via a bus.

The computer code may be stored within the memory of the control unit. The computer code may include modules such as a window acquisition module that acquires the first and second windows based on sensor data, and a tuning module that determines the first and second vectors within the first and second windows, respectively. If only a single LNB is used, the computer code may include the above plus a vector manipulation module that mathematically uses the first and second vectors to obtain the third vector, and an arc adjustment module that adjusts the third vector to obtain the skew angle.

Through the use of the apparatus and method of the invention, satellite signal cross polarization may be more rapidly and/or accurately accomplished, without involvement from a satellite operation center. These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a network including a plurality of satellites in geosynchronous orbit and an Earth-based communication station;

FIG. 2 is a schematic block diagram of the communication station of FIG. 1;

FIG. 3 is a schematic block diagram illustrating various hardware components of the control unit of the communication station of FIG. 1;

FIG. 4 is a logical block diagram depicting cross polarization of the antenna of FIG. 1;

FIG. 5 is a flowchart diagram illustrating a cross polarization method that may be carried out in the logical block diagram of FIG. 4;

FIG. 6 is a logical block diagram depicting cross polarization of an antenna of a communication station according to one alternative embodiment of the invention; and

FIG. 7 is a flowchart diagram illustrating a cross polarization method that may be carried out in the logical block diagram of FIG. 6.

### DETAILED DESCRIPTION OF THE PREFERRED EMBODIMENTS

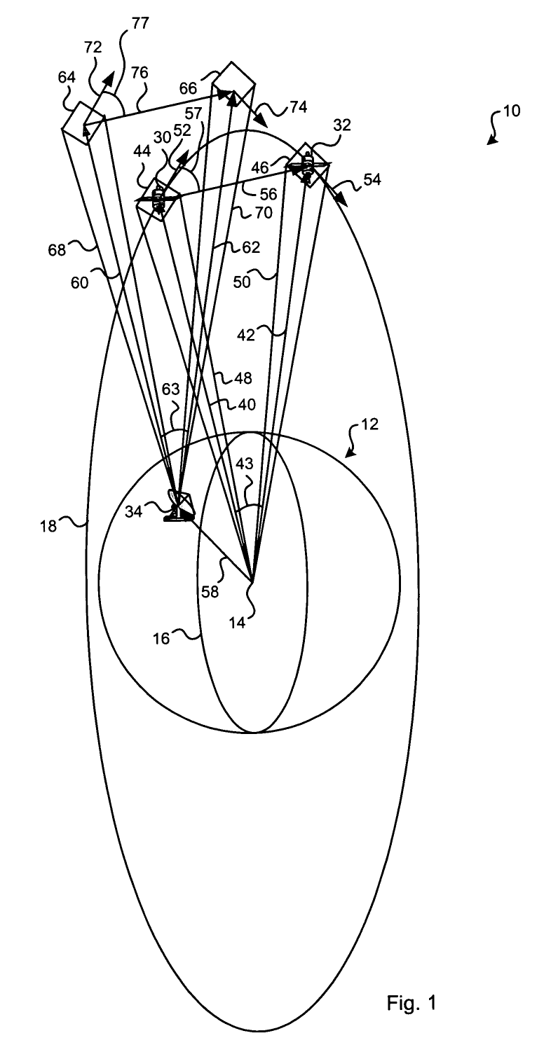

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 7, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects. The terms “rotate” and “pivot” are used interchangeably to refer generally to turning about an axis; neither term implies any limitation of the angle through which rotation is able to occur.

Referring to FIG. 1, a perspective view illustrates a network 10 in which the cross polarization system and method of the present invention may be employed. FIG. 1 depicts the Earth 12, which has a center 14 and an Equator 16. The Clark Belt 18 is also shown encircling the Equator 16. The Earth 12 and the Clark Belt 18 are shown by way of illustration, and may not be to scale in FIG. 1.

As shown, the network 10 includes a first transmitter 30, a second transmitter 32, and a communication station 34. The invention is usable with a wide variety of wireless transmission systems, including satellites and ground-based antennas. In the embodiment of FIG. 1, the first transmitter 30 is a first satellite and the second transmitter is a second satellite 32. The first and second satellites 30, 32 are disposed in geosynchronous orbit around the Earth 12, and are thus positioned in the Clark Belt 18, as shown. The communication station 34 is disposed at some arbitrary point on the surface of the Earth 12.

The present invention provides a system and method whereby the communication station 34 may be rapidly and easily configured to communicate with a transmitter such as the first satellite 30 or the second satellite 32. The communication station 34 may, according to one example, be mounted on a vehicle. The communication station 34 must therefore be reconfigured for communication with the first or second satellite 30, 32 each time the vehicle stops moving and communication is desired. In this application, “communication” involving an antenna refers to transmission of a wireless signal to and/or from the antenna.

The first satellite 30 is displaced from the center 14 of the Earth 12 by a first vector 40, and the second satellite 32 is displaced from the center 14 of the Earth 12 by a second vector 42. The first and second vectors 40, 42 are separated from each other by an angle 43. When setup of the communication station 34 commences, the first and second vectors 40, 42 may not be directly available to the communication station, but may be obtained to provide cross polarization, as will be described hereafter. In this application, a “vector” comprises a geometric displacement of at least two dimensions. A “vector” may be expressed in a variety of coordinate systems including Cartesian, spherical, and cylindrical coordinates.

The first satellite 30 has a first satellite drift area 44 that surrounds its nominal position on the Clark Belt 18. According to one example, the first satellite drift area 44 may be generally square in shape, and may be on the order of seventy-by-seventy miles in size. The first satellite 30 may be permitted to drift within the first satellite drift area 44 until the first satellite 30 approaches the edge of the first satellite drift area 44, at which point thrusters may be engaged to return the first satellite 30 to its nominal position at the center of the first satellite drift area. The second satellite 32 similarly has a second satellite drift area 46 that surrounds its nominal position on the Clark Belt 18.

Due to satellite drift, the first and second vectors 40, 42 are not initially known to the communication station. However, the first and second satellite drift areas 44, 46 are stationary, and their locations can thus be obtained with reference to the communication station 34 once the position and orientation of the communication station 34 are known. As will be described subsequently, the communication station has sensors that provide position and orientation data to enable the first and second satellite drift areas 44, 46 to be located with respect to the communication station 34.

Location of the first and second satellite drift areas 44, 46 provides first and second windows 48, 50. The first window 48 is the space within which the first vector 40 may be disposed, and comprises the volume between the center 14 of the Earth 12 and the first satellite drift area 44. The first window 48 may comprise a generally inverted pyramidal shape. Similarly, the second window 50 is the space within which the second vector 42 may be disposed, and comprises the volume between the center 14 of the Earth 12 and the second satellite drift area 46.

As shown, the first satellite 30 has a first tangent 52 to the Clark Belt 18. The antenna (for example, dish) of the first satellite 30 is oriented generally parallel to the first tangent 52. Thus, the dish (not shown) faces the Earth such that one of the polarized signals is transmitted within the plane of the Clark Belt 18, while the other is transmitted substantially perpendicular to the plane of the Clark Belt 18. The communication station 34 will receive a first signal from the first satellite 30 at maximum strength when the antenna (not shown) of the communication station 34 is disposed parallel to the dish of the first satellite 30.

Similarly, the second satellite 32 has a second tangent 54 to the Clark Belt 18, and the antenna of the second satellite 32 is oriented generally parallel to the second tangent 54. The communication station 34 will receive a second signal from the second satellite 32 at maximum strength when the antenna of the communication station 34 is disposed parallel to the dish of the second satellite 32.

Consequently, proper cross polarity for receiving the first signal from the first satellite 30 can be obtained by disposing the antenna of the communication station 34 parallel to the first tangent 52. Similarly, proper cross polarity for receiving the second signal from the second satellite 32 can be obtained by disposing the antenna of the communication station 34 parallel to the second tangent 54. The first tangent 52 or the second tangent 54 may be obtained via the intermediate step of obtaining a third vector 56 that extends between the first and second satellites 30, 32.

The third vector is offset from each of the first and second tangents 52, 54 by an angle 57 equal to half the angle 43 between the first and second vectors 40, 42. Thus, when the first and second vectors 40, 42 have been obtained, the third vector 56 may be obtained by processing the first and second vectors 40, 42. The first or second tangent 52, 54, including the offset angle, may then be derived from the third vector 56. Alternatively, if a desired signal is to be received from a third satellite (not shown) midway between the first and second satellites 30, 32, the third vector 56 will be parallel to the tangent to the third satellite, so the third vector 56 may be used without adjustment to provide the skew angle. The third satellite must simply be angularly halfway between the first and second satellites 30, 32, i.e., the third satellite must bisect the angle 43 between the first and second vectors 40, 42.

As illustrated, the communication station 34 is displaced from the center 14 of the Earth 12 by a communication station location vector 58. The antenna of the communication station 34 is to be disposed parallel to the antenna of the satellite with which it communicates, regardless of the location of the communication station 34 on the Earth 12. Thus, the first and second vectors 40, 42 may be repositioned for purposes of illustration. This is shown in FIG. 1 in the form of first and second vectors 60, 62, separated by an angle 63, first and second satellite drift areas 64, 66, first and second windows 68, 70, first and second tangents 72, 74, a third vector 76, and an angle 77 that are the same as those discussed above, but have the communication station 34 as their origin.

These repositioned vectors and angles may be analyzed to determine the skew angle in the same manner described previously. Hence, the antenna of the communication station 34 is positioned for optimal communication with the first satellite 30 when the first vector 60 is normal to the antenna. Similarly, the antenna of the communication station 34 is positioned for optimal communication with the second satellite 32 when the second vector 62 is normal to the antenna.

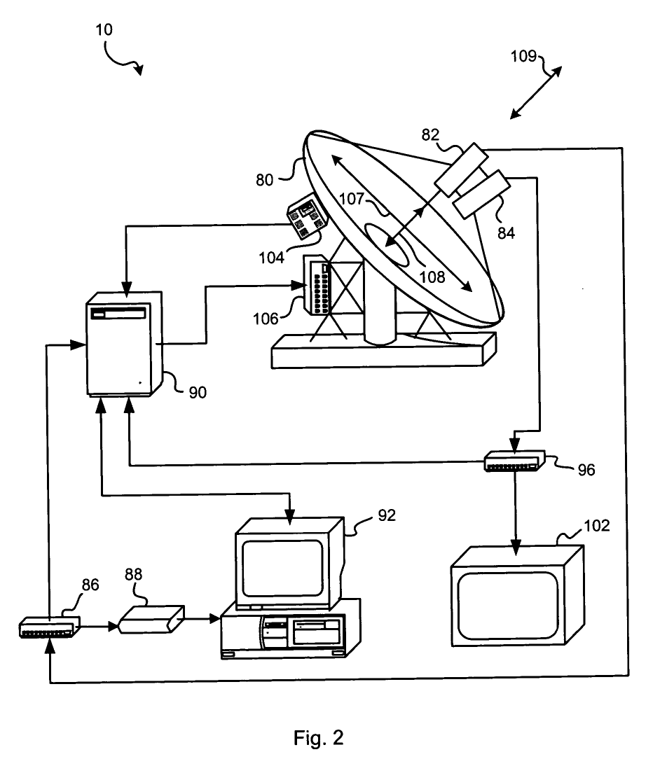

Referring to FIG. 2, a schematic block diagram illustrates various components of the communication station 34. As mentioned previously, the communication station 34 may be mounted on a vehicle (not shown). The term “communication station” is not limited to the combination of elements illustrated in FIG. 2, but may include any component or combination of components that provides wireless communication with at least one polarized signal transmitter. In the embodiment of FIG. 2, the communication station 34 has an antenna 80, which may be generally dish-like in shape. If desired, the antenna 80 may have a generally rectangular or elliptical, rather than circular, profile.

A first LNB (low noise block down conversion device) 82 is coupled to the antenna 80 so that electromagnetic signals such as microwave signals can bounce from the antenna 80 and be received by the first LNB 82. The first LNB 82 converts the received electromagnetic signals into an electrical RF signal. A second LNB 84 may operate in a similar manner and may also be coupled to the antenna 80. In this application, an “antenna” need not necessarily convert wireless signals to electrical signals, but may simply reflect the wireless signals for receipt by a separate device, such as an LNB.

The second LNB 84 may be angled from the first LNB 82 so that the second LNB 84 receives signals from a different angle than the first LNB 82. For example, the first LNB 82 may receive signals from a source perpendicular to the antenna 80, while the second LNB 84 receives signals from a source offset from perpendicularity to the antenna 80. The first and second LNB's 82, 84 may thus be used simultaneously to communicate with two different satellites. If desired, the first LNB 82 may provide two-way communication for Internet access and the second LNB 84 may receive television signals.

The electrical RF signal from the first LNB 82 may be conveyed to an RF splitter 86 that further conveys the RF signal to a modem 88 and to a control unit 90. The modem 88 may include components such as a mixer/oscillator (downconverter) designed to convert the RF signal to an IF frequency for broadband demodulation, an ADC (analog-to-digital converter), and/or any other components needed to convert the RF signal to digital, computer readable form.

The modem 88 transmits the computer-readable signals to a personal computer 92. As mentioned previously, the first LNB 82 may be designed to provide Internet access. The personal computer 92 may be connected to the control unit 90 in such a manner that the personal computer 92 can be used to initiate satellite acquisition and/or cross polarization via operation of the control unit 90, or to modify the operation of the control unit 90.

The electrical RF signal from the second LNB 84 may be conveyed to an RF splitter 96 that further conveys the RF signal to a television display screen 102 and to the control unit 90. As mentioned previously, the second LNB 84 may be designed to receive television signals.

The control unit 90 may also be connected to a sensor array 104 attached to the antenna 80. The sensor array 104 includes sensors such as a GPS (global positioning satellite) receiver, a compass, a level, and a tilt indicator (not shown). The sensor array 104 may thus provide three dimensional location data and three dimensional orientation data so that the disposition of the antenna 80 is fully obtained.

The control unit 90 is also connected to a motor array 106 coupled to the antenna 80 to rotate the antenna 80 about three axes: an azimuth axis 107, an elevation axis 108, and a skew axis 109. The motor array 106 may thus have a plurality of motors, such as rotary electrical motors, linear actuators, or any other known motors and/or actuators. The axes 107, 108, 109 are shown by arrows in FIG. 2. The azimuth axis 107 extends between the vertical extents of the antenna 80, the elevation axis 108 extends between the sides of the antenna 80, and the skew axis 109 is perpendicular to the antenna 80. Rotation along the azimuth axis 107 and the elevation axis 108 may be used to bring the antenna 80 parallel to the corresponding antenna of the first or second satellites 30, 32, while rotation along the skew axis 109 may be used to cross polarize the first or second signals with the antenna 80. This concept will be described in greater detail subsequently.

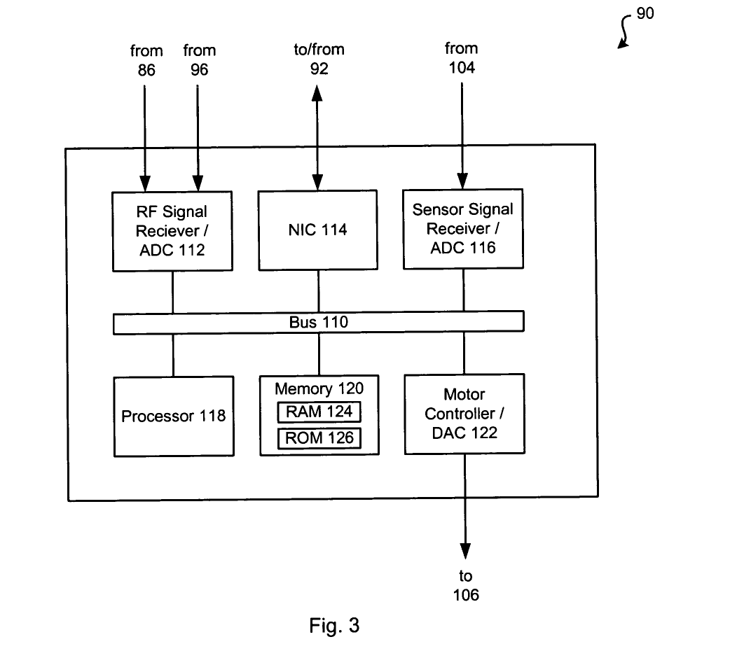

Referring to FIG. 3, a schematic block diagram illustrates the control unit 90 in greater detail. As shown, the control unit 90 may have various components designed to permit the control unit 90 to substantially automatically set up the antenna 80 for communication with the first satellite 30 or the second satellite 32. The components may include a bus 110, an RF signal receiver/ADC (analog-to-digital converter) 112, a NIC (network interface card) 114, a sensor signal receiver/ADC 116, a processor 118, a memory 120, and a motor controller/DAC (digital-to-analog converter) 122. The bus 110 may serve to digitally connect the other components of the control unit 90 together.

The RF signal receiver/ADC may receive the RF signals from the first and second LNB's 82, 84 via the splitters 86, 96, and may convert them into digital form for processing. The NIC 114 may be designed to transmit data to and from the personal computer 92, and may include any of a variety of digital connection types including Ethernet, parallel, serial, USB, USB2, and firewire (IEEE 1394) connections. The NIC 114 may receive commands from the personal computer 92, such as commands to set up the antenna 80 for communication, to adjust the antenna 80 to enhance communication quality, or to fold the antenna 80 for storage or travel. The NIC 114 may also be used to provide feedback to the personal computer 92, such as the current status of the antenna 80 and/or the quality and strength of the signals received.

The sensor signal receiver/ADC 116 is coupled to the sensor array 104 to receive position and orientation data from the sensor array 104. As mentioned previously, the sensor array 104 may include a GPS receiver, a compass, a level, and a tilt indicator that cooperate to provide three dimensional position data and three dimensional orientation data. The position and orientation data are converted to digital form for use in the antenna alignment/cross polarization process.

The processor 118 may comprise any of a number of structures designed to process digital signals. For example, the processor 118 may be a microprocessor, a RISC (reduced instruction set) processor, an ASIC (application specific integrated circuit), or an FPGA (field programmable gate array). The processor 118 generally carries out simple instructions like signal strength logging and comparison, vector mathematics, and the like.

The memory 120 may include RAM (random access memory) 124 and ROM (read only memory) 126. If desired, the ROM 126 may be true read-only memory such as a PROM (programmable read only memory). Alternatively, EEPROMs (electrically erasable and programmable read only memory), a hard drive, or the like may be used. The ROM 126 may contain executable instructions or other data. The ROM 126 may contain the instructions to perform the methods outlined in connection with the discussion of FIG. 1.

The RAM 124 may contain data such as the position and orientation data, signal strength data for comparison, vector data such as the first and second vectors 60, 62, and the like. The RAM 124 may use any type of rewritable memory, including EEPROMs, DIMM or SIMM modules, or the like. Alternatively, the RAM 124 and the ROM 126 may be integrated, with executable code and operating data stored in the same type of memory.

The motor controller/DAC 122 may include circuitry to receive digital signals from the bus 110 and to convert them into control signals suitable for receipt by the motor array 106. The control signals may provide position commands, displacement commands, or the like to any given motor of the motor array 106. If desired, the motor array 106 may provide feedback to the motor controller/DAC 122 to indicate the positions of the motors, thereby enabling further tuning of the motor positions.

In the communication station 34 of FIG. 2, the control unit 90 is configured to operate substantially independently to configure the antenna 80 for communication. In alternative embodiments, some of the functions of the control unit 90 may be moved to the personal computer 92 to simplify the configuration and operation of the control unit 90. Some of the structures described above may thus be omitted or moved to the personal computer 92. In certain embodiments, the control unit 90 may be omitted entirely, and all of its functions may be carried out by a personal computer with hardware such as motor control cards and sensor signal receipt cards. In the alternative or in addition to the above, the control unit 90 may be minimized, mounted on the antenna 80, and/or integrated with the sensor array 104 and/or the motor array 106.

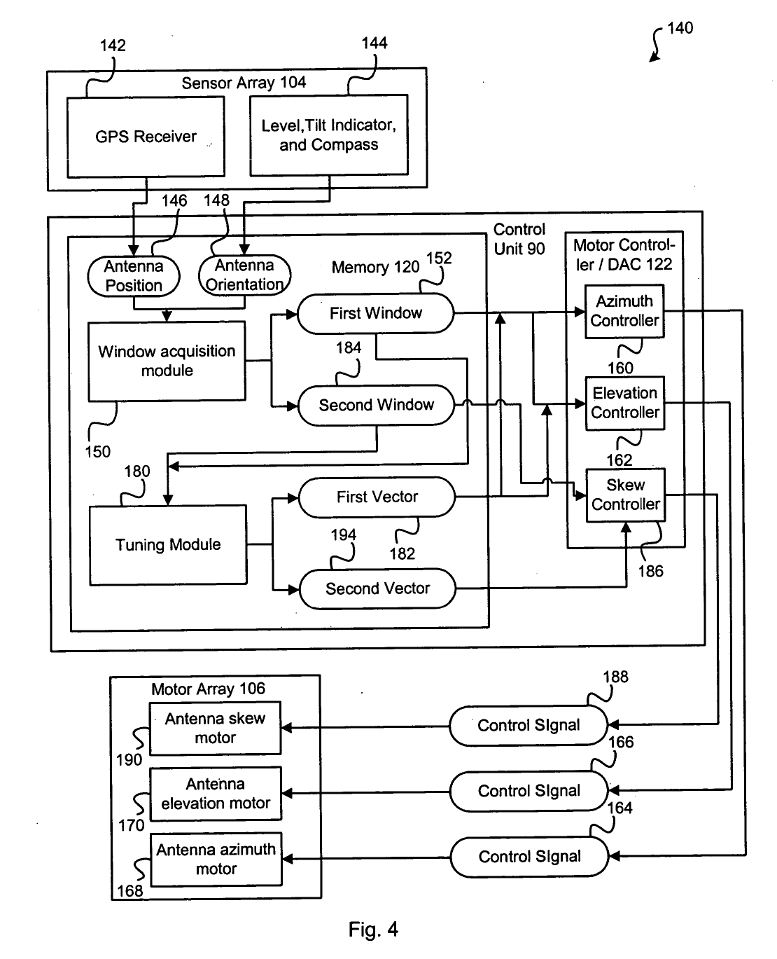

Referring to FIG. 4, a logical block diagram 140 provides greater detail regarding how the communication station 34 may be configured to communicate with a satellite, such as the first satellite 30 of FIG. 1. Various components of the communication satellite 34, including the control unit 90, the sensor array 104, and the motor array 106, are illustrated in logical block form.

As shown, the sensor array 104 has a GPS receiver 142 that receives signals broadcast by GPS (global positioning system) satellites (not shown). The sensor array 104 also has a level, tilt indicator, and compass 144. The level, tilt indicator, and compass 144 provide measurements of the angular displacement of the antenna 80, which are somewhat analogous to the pitch, roll, and yaw, respectively, of a plane. As shown, the GPS receiver 142 provides an antenna position 146, and the level, tilt indicator, and compass 144 provides an antenna orientation 148, to the control unit 90. As mentioned previously, the antenna position 146 and the antenna orientation 148 may each include three dimensional data.

The antenna position 146 and the antenna orientation 148 are received by a window acquisition module 150, which may reside within the memory 120 of the control unit 90, such as within the ROM 126. The window acquisition module uses the antenna position 146 and antenna orientation 148, in combination with the known location of the first satellite drift area 44, to determine the first window 152, which corresponds to either of the first windows 48, 68 of FIG. 1.

The window acquisition module 150 transmits instructions to the motor controller/DAC 122 to initiate motion of the antenna 80 to point to the first window 152. “Pointing to the first window” comprises orienting the antenna 80 generally normal to some vector, originating from the communication station 34, within the first window 152. Orienting the antenna 80 in such a manner comprises rotating the antenna 80 about the azimuth and elevation axes 107, 108. Thus, the instructions are transmitted to an azimuth controller 160 and an elevation controller 162 of the motor controller/DAC 122. The azimuth controller 160 and the elevation controller 162 send control signals 164, 166, respectively, to an antenna azimuth motor 168 and an antenna elevation motor 170 of the motor controller 10.

The first window 152 also gets passed to a tuning module 180, which also resides within the memory 120. The tuning module 180 receives the first window 152 and initiates motion of the antenna 80 along a pattern to generally point along vectors throughout the first window 152. The tuning module 180 continuously receives data indicating the strength of the signal received, which may be obtained via the RF signal receiver/ADC 112. When the signal strength reaches a maximum value within the first window 152, the tuning module 180 records the vector at which the antenna 80 is pointing. This vector is the first vector 182, which corresponds to the first vectors 40, 60 of FIG. 1. This process may be termed “peaking” the antenna 80 on the first satellite 30. Although this process may involve trial and error, the peaking process is not the same as the trial and error process traditionally used to obtain the proper skew angle through the use of a satellite operation center.

The tuning module 180 transmits instructions to the motor controller/DAC 122 to trigger motion of the antenna 80 to point at the first vector 182, or to stop motion of the antenna 80 if the antenna 80 is already pointing at the first vector 182. Again, the instructions are transmitted to the azimuth controller 160 and the elevation controller 162. The azimuth controller 160 and the elevation controller 162 again send control signals 164, 166, respectively, to the antenna azimuth motor 168 and the antenna elevation motor 170 to obtain the desired position of the antenna 80.

The first LNB 82 is used to acquire the first window 152 and the first vector 182. When the antenna 80 has been oriented to point along the first vector 182, the first LNB 82 receives the first signal from the first satellite 30 at maximum strength. The window acquisition module 150 then determines the second window 184 via processing of the antenna position 146, the antenna orientation 148, and the known location of the second satellite drift area 46. Instructions are sent to a skew controller 186 of the motor controller/DAC 122 to trigger orientation of the antenna 80. The skew controller 186 transmits a control signal 188 to an antenna skew motor 190 of the motor array 106 so that the antenna 80 remains pointed along the first vector 182 via the first LNB 82, and the antenna 80 simultaneously points toward the second window 184 via the second LNB 84.

The second window 184 is also transmitted to the tuning module 180, which moves the antenna 80 via rotation only about the skew axis 109 to point along various vectors within the second window 184. When the signal strength reaches a peak within the second window 184, the tuning module 180 records the vector at which the antenna 80 is pointing via the second LNB 84. This is a second vector 194, which corresponds to the second vectors 42, 62 of FIG. 1. The tuning module 180 transmits instructions to the skew controller 186, and the skew controller 186 transmits a control signal 188 to the antenna skew motor 190 to move the antenna 80 such that the antenna 80 points along the second vector 194 via the second LNB 84.

Once the antenna 80 has been rotated along the azimuth, elevation, and skew axes 107, 108, 109 to simultaneously point along the first and second vectors 182, 194, via the first and second LNB's 82, 84, respectively, the antenna 80 is disposed at the proper skew angle for receiving the first and second signals from the first and second satellites 30, 32. The first and second LNB's 82, 84 are angled in such a manner that proper cross polarization is obtained with the first and second satellites 30, 32 at the same skew angle of the antenna 80.

This is accomplished without necessarily processing the first and second vectors 182, 194. Hence, recording the first and second vectors 182, 194 is optional because as long as the antenna 80 is pointed toward the first and second vectors 182, 194, proper cross polarization is achieved. Hence, “obtaining” or “determining” the first and second vectors 182, 194 need not include recording or processing the first and second vectors 182, 194 mathematically. Rather, the first and second vectors 182, 194 may be obtained implicitly by pointing the antenna 80 along the first and second vectors 182, 194.

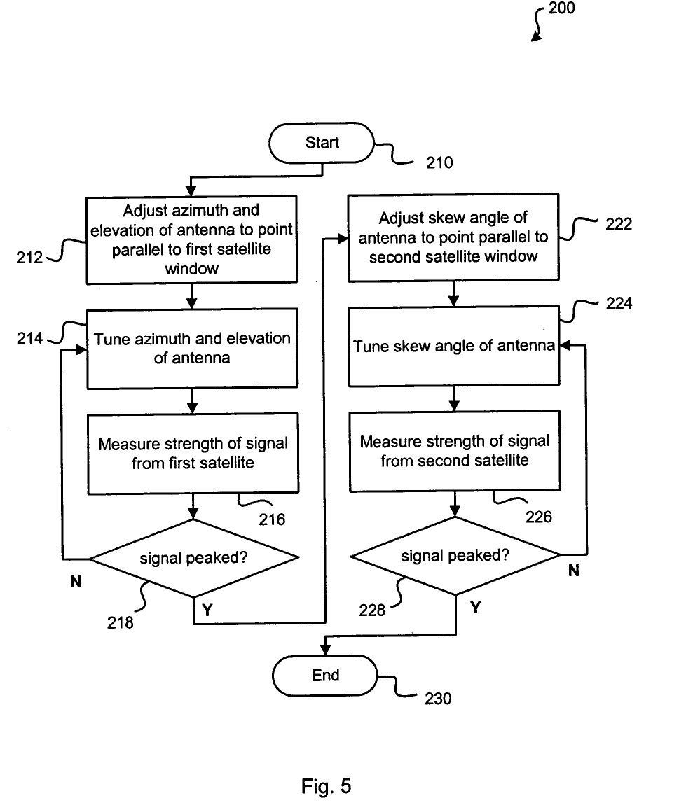

Referring to FIG. 5, a flowchart diagram illustrates the cross polarization method 200, or method 200, followed in the logical block diagram 140 of FIG. 4. The method 200 starts 210 with adjusting 212 the azimuth and elevation of the antenna 80 to point parallel to the first window 152. Then, the azimuth and elevation of the antenna 80 are tuned 214 via motion of the antenna 80. The strength of the first signal from the first satellite 30 is measured 216, for example periodically.

If the first signal from within the first window 152 has not peaked 218, i.e., reached a maximum strength, the method 200 continues with the tuning operation 214 until a peak has been reached. If the first signal from within the first window 152 has peaked 218, the skew angle of the antenna 80 is adjusted 222 such that the antenna 80 points to the second window 184. As mentioned in connection with the previous embodiment, when two LNB's are used, communication may be maintained with the first satellite 30 while the antenna is being oriented about the skew axis 109 to communicate with the second satellite 32.

The skew angle of the antenna 80 is then tuned 224 by rotating the antenna 80 about the skew axis 109 such that the antenna 80 points to a plurality of vectors within the second window 184. The strength of the second signal from the second satellite 32 is measured 226, for example, periodically. If the second signal from within the second window 184 has not peaked 228, the method 200 continues with the tuning operation 224 until a peak has been reached. If the second signal from within the second window 184 has peaked 228, the method 200 ends 230 because the antenna 80 has been properly cross polarized to receive the first and second signals from the first and second satellites 30, 32, respectively.

The accuracy of the skew angle is depends upon how far apart the first and second satellites 30, 32 are. Greater angular displacement between the first and second satellites 30, 32 provides a greater accuracy. An angular displacement of fifteen degrees, for example, results in a skew angle with an error of less than about plus or minus 0.6 degrees. Total cross polarization error, including satellite wobble and drift, should then be less than about plus or minus two degrees. The angular displacement of the first and satellites 30, 32, with respect to the antenna 80, is determined by the positioning of the first and second LNB's 82, 84. However, in the following method, only the first LNB 82 is used, and enables determination of the skew angle based on satellites with a larger or smaller angular displacement.

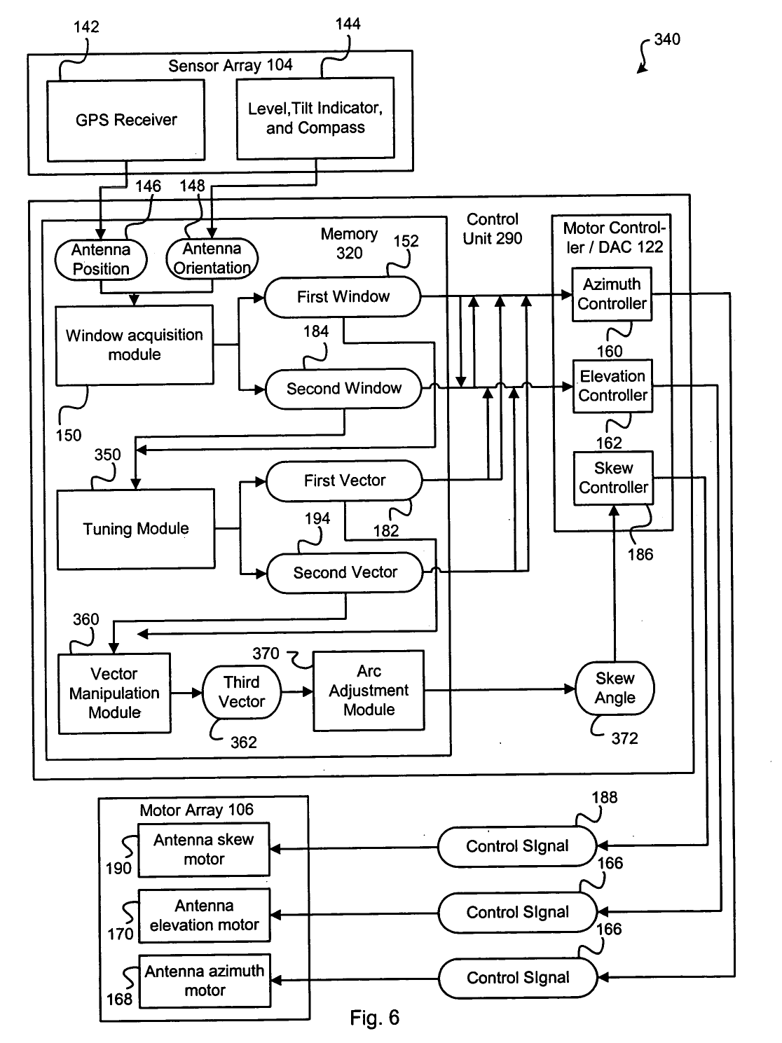

Referring to FIG. 6, a control unit 290 according to one alternative embodiment of the invention is illustrated. The control unit 290 has a memory 320 analogous to the memory 120 of the control unit 90 described previously. The control unit 290 may be incorporated into a communication station (not shown) that is like the communication station 34 of FIG. 2, except for the differences in the control unit 290, which will be set forth in greater detail below, and the fact that only a single LNB (such as the first LNB 82 of FIG. 2) is included.

FIG. 6 illustrates a logical block diagram 340 in which the control unit 290 is incorporated. As shown, a sensor array 104 like that of FIG. 4 is coupled to the control unit 290. The sensor array 104 has a GPS receiver 142 and a level, tilt indicator, and compass 144, which provide the antenna position 146 and the antenna orientation 148, respectively, to the control unit 290. The control unit 290 has a window acquisition module 150 like that of the previous embodiment. The window acquisition module 150 is stored in the memory 320, and operates in a manner substantially similar to the window acquisition module 150 of FIG. 4. Hence, the window acquisition module 150 processes the antenna position 146 and the antenna orientation 148, in combination with the known first satellite drift area 44, to provide the first window 152.

As in the logical block diagram 140 of FIG. 4, the window acquisition module 150 instructs the azimuth controller 160 and the elevation controller 162 of the motor controller/DAC 122 to orient the antenna 80 to point toward the first window 152. The azimuth controller 160 and the elevation controller send control signals 164, 166 to the antenna azimuth motor 168 and the antenna elevation motor 170 to induce rotation of the antenna 80.

The first window 152 is also conveyed to a tuning module 350 that receives the first window 152 and instructs the azimuth controller 160 and the elevation controller 162 to move the antenna 80 to point along a plurality of vectors within the first window 152. The tuning module 350 receives signal strength data and instructs the azimuth controller 160 and the elevation controller 162 to move to a first vector 182 (or stop moving at the first vector 182). Again, control signals 164, 166 are sent to the antenna azimuth motor 168 and the antenna elevation motor 170 to induce rotation of the antenna 80. The first vector 182 is the vector within the first window 152 along which the signal strength is maximized.

The window acquisition module 150 then obtains the second window 184 in a manner similar to that of the first window 152. More precisely, the window acquisition module 150 uses the antenna position 146 and the antenna orientation 148, in combination with the known second satellite drift area 46, to provide the second window 184. Since only the first LNB 82 is present, the antenna 80 cannot communicate with multiple satellites simultaneously. Accordingly, the antenna 80 must be moved between communication with the first satellite 30 and communication with the second satellite 32. The azimuth controller 160 and the elevation controller 162 are instructed to initiate motion of the antenna to point to the second window. Control signals 164, 166 are transmitted to the antenna azimuth motor 168 and the antenna elevation motor 170 to rotate the antenna 80 accordingly.

The second window 184 is also conveyed to the tuning module 350, which moves the antenna 80 to point along a plurality of vectors within the second window. When the second vector 194, i.e., the vector within the second window 184 along which the greatest signal strength is received, is determined by the tuning module 350, the first and second vectors 182, 194 are conveyed to a vector manipulation module 360 that mathematically manipulates the first and second vectors 182, 194 to obtain a third vector 362, which is analogous to the third vectors 56, 76 illustrated in FIG. 1.

The third vector 362 extends from the first satellite 30 to the second satellite 32. The third vector 362 may, for example, be obtained by subtracting the first vector 182 from the second vector 194. The third vector 362 is then conveyed to an arc adjustment module 370 that adds an offset to the third vector 362 to obtain the first tangent 52 (shown in FIG. 1). As mentioned previously, the offset is the angle 57 or 77, as shown in FIG. 1, which is readily determined because it is half the angle 43 or 63. The angle 43 or 63 between the first and second vectors 182, 194 is easily determined via vector mathematics.

The first tangent 52 is disposed at the skew angle; thus, finding the first tangent 52 results in obtaining a skew angle 372 to which the antenna 80 is to be rotated about the skew axis 109 to provide proper cross polarization. The skew controller 186 of the motor controller/DAC 122 is instructed to dispose the antenna 80 at the skew angle 372. Hence, the skew controller 186 transmits a control signal 188 to the antenna skew motor 190 of the motor array 106. The antenna 80 is then rotated to the skew angle 372 for cross polarization.

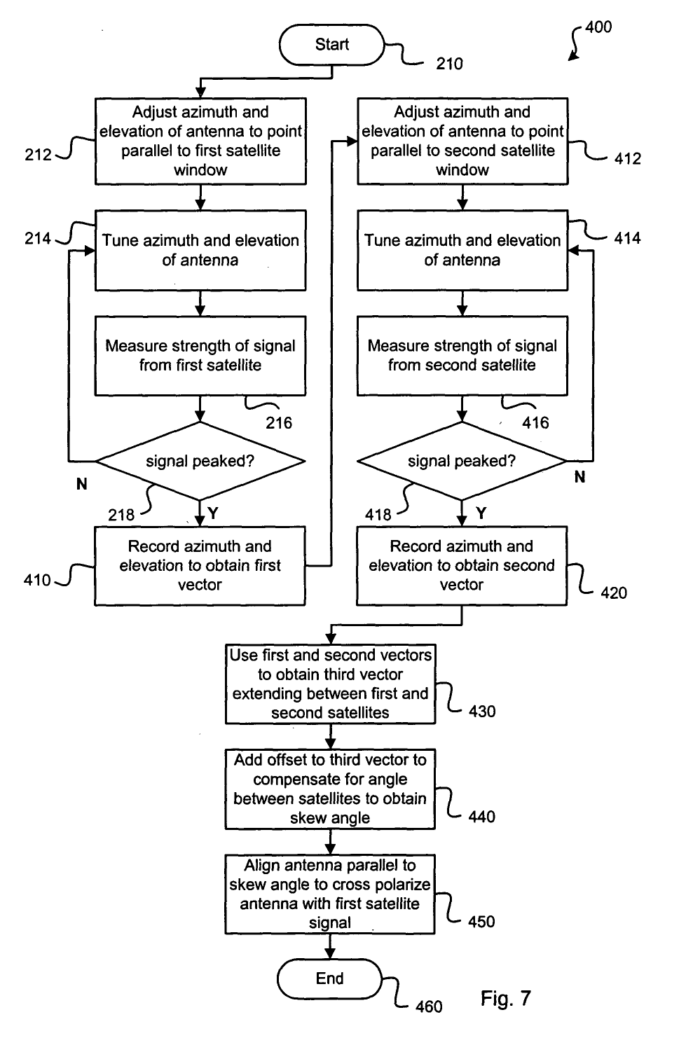

Referring to FIG. 7, a flowchart diagram illustrates a cross polarization method 400, or method 400, that may be followed by the logical block diagram 340 of FIG. 6. As shown, the method 400 starts 210 with adjusting 212 the azimuth and elevation of the antenna 80 to point parallel to the first window 152. Then, the azimuth and elevation of the antenna 80 are tuned 214 via motion of the antenna 80. The strength of the first signal from the first satellite 30 is measured 216, for example periodically.

If the first signal from within the first window 152 has not peaked 218, i.e., reached a maximum strength, the method 400 continues with the tuning operation 214 until a peak has been reached. If the first signal from within the first window 152 has peaked 218, the azimuth and elevation along which the peak signal was obtained are recorded 410 to obtain the first vector 182.

Then, the azimuth and elevation of the antenna 80 are adjusted 412 to point parallel to the second window 184. The azimuth and elevation of the antenna 80 are tuned 414 via motion of the antenna 80, and the strength of the second signal from the second satellite 32 is measured 416, for example periodically.

If the second signal from within the second window 184 has not peaked 418, i.e., reached a maximum strength, the method 400 continues with the tuning operation 414 until a peak has been reached. If the second signal from within the second window 184 has peaked 418, the azimuth and elevation along which the peak signal was obtained are recorded 420 to obtain the second vector 194.

The first and second vectors 182, 194 are then used 430 to obtain a third vector 362 extending from the first satellite 30 to the second satellite 32. An offset is added 440 to the third vector 362 to provide the skew angle 372. As mentioned before, the offset is equal to half the angle between the first and second vectors 182, 194. The antenna 80 is then aligned 450 with the skew angle 372 to cross polarize the antenna 80 with respect to the first signal. As an alternative, the third vector 362 may be offset by the same angle in the opposite direction to cross polarize the antenna 80 with respect to the second signal. However, since the antenna 80 has only the first LNB 82, the antenna 80 cannot simultaneously be properly aligned and/or cross polarized with the first and second satellites 30, 32.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A communication station for receiving a desired signal via an antenna disposable at a skew angle to receive the desired signal, the communication station comprising:
a control unit comprising:
a memory containing data structures comprising a tuning module configured to determine a first vector corresponding to communication of the antenna with a first transmitter and a second vector corresponding to communication of the antenna with a second transmitter; and
a motor controller electrically coupled to the memory to trigger orientation of the antenna to permit communication with the first and second transmitters via the first and second vectors to facilitate determination of the skew angle.

2. The communication station of claim 1, further comprising the antenna.

3. The communication station of claim 2, wherein the control unit further comprises a motor assembly controllable by the motor controller to pivot the antenna about an elevation axis and an azimuth axis to orient the antenna to communicate with the first transmitter, wherein the motor assembly is further configured to pivot the antenna about a skew axis to align the antenna with the skew angle.

4. The communication station of claim 2, wherein the antenna is shaped to reflect a first signal from the first transmitter, the communication station further comprising a first LNB disposed to receive the first signal after reflection from the antenna.

5. The communication station of claim 4, wherein the data structures further comprise a vector manipulation module configured to mathematically process the first and second vectors to obtain a third vector extending between the first and second transmitters, wherein the skew angle is derived from the third vector.

6. The communication station of claim 5, wherein the desired signal is to be received from the first transmitter, the first transmitter comprising a first dish, wherein the data structures further comprise an arc adjustment module configured to offset the third vector to provide the skew angle such that, when the antenna is disposed at the skew angle, the antenna is substantially parallel to the first dish.

7. The communication station of claim 4, further comprising a second LNB disposed to receive a second signal from the second transmitter after reflection of the second signal from the antenna, wherein the first and second LNB's are relatively disposed such that the antenna is able to simultaneously receive the first and second signals via the first and second LNB's, respectively.

8. The communication station of claim 7, wherein the tuning module is configured to communicate with the motor controller to pivot the antenna about the elevation and azimuth axes to obtain the first vector, and then exclusively about the skew axis to simultaneously obtain the second vector and dispose the antenna at the skew angle.

9. The communication station of claim 1, further comprising a sensor array coupled to the antenna to provide location and orientation data to the control unit.

10. The communication station of claim 9, wherein the data structures further comprise a window acquisition module configured to receive the location and orientation data and to utilize the location and orientation data to obtain a first window, within which the first vector is disposed, and a second window, within which the second vector is disposed.

11. The communication station of claim 10, wherein the tuning module receives the first and second windows and initiates motion of the antenna to receive a first signal and a second signal from within the first and second windows, respectively, wherein the tuning module receives signal strength data from within the first and second windows to find vectors along which signal strength is maximized within the first and second windows, thereby determining the first and second vectors, respectively.

12. The communication station of claim 9, wherein the sensor array comprises a global positioning satellite (GPS) receiver, a level, a tilt indicator, and a compass, the communication station further comprising a first LNB configured to receive the desired signal and convert the desired signal into an analog signal, a splitter configured to convey the analog signal to the control unit and to a modem configured to convert the analog signal to a digital signal, and a computer coupled to the modem to receive the digital signal.

13. The communication station of claim 1, wherein the first transmitter comprises a first satellite and the second transmitter comprises a second satellite, wherein the first satellite comprises a first dish oriented substantially perpendicular to the first vector and the second satellite comprises a second dish oriented substantially perpendicular to the second vector, wherein the tuning module is configured to orient the antenna substantially parallel to the first dish to enable communication of the antenna with the first satellite and to orient the antenna substantially parallel to the second dish to enable communication of the antenna with the second satellite.

14. The communication station of claim 13, wherein the second satellite is displaced from the first satellite by at least fifteen degrees with respect to the antenna.

15. A communication station for receiving a desired signal via an antenna disposable at a skew angle to receive the desired signal, the communication station comprising:
a control unit comprising:
a memory containing data structures comprising:
a tuning module configured to determine a first vector corresponding to communication of the antenna with a first transmitter and a second vector corresponding to communication of the antenna with a second transmitter; and
a vector manipulation module configured to process the first and second vectors to determine the skew angle.

16. The communication station of claim 15, wherein the first transmitter comprises a first satellite and the second transmitter comprises a second satellite, wherein the first satellite comprises a first dish and the second satellite comprises a second dish, wherein the control unit further comprises a motor controller electrically coupled to the memory to trigger orientation of the antenna substantially parallel to the first dish to permit communication of the antenna with the first satellite and to trigger orientation of the antenna substantially parallel to the second dish to permit communication of the antenna with the second satellite.

17. The communication station of claim 16, wherein the vector manipulation module is configured to determine a third vector extending between the first and second satellites.

18. The communication station of claim 17, wherein the desired signal is to be received from the first satellite, the data structures further comprising an arc adjustment module configured to offset the third vector to provide the skew angle such that, when the antenna is disposed at the skew angle, the antenna is substantially parallel to the first dish.

19. The communication station of claim 17, wherein the desired signal is to be received from a third satellite disposed generally midway between the first and second satellites such that the third vector provides the skew angle substantially without adjustment.

20. The communication station of claim 15, further comprising the antenna, a sensor array coupled to the antenna to provide location and orientation data to the control unit, and a motor assembly controllable by the motor controller to pivot the antenna about an elevation axis, an azimuth axis, and a skew axis.

21. The communication station of claim 20, wherein the data structures further comprise a window acquisition module configured to receive the location and orientation data and to utilize the location and orientation data to obtain a first window, within which the first vector is disposed, and a second window, within which the second vector is disposed, wherein the tuning module receives the first and second windows and initiates motion of the antenna to receive a first and second signals from within the first and second windows, respectively, wherein the tuning module receives signal strength data from within the first and second windows to find vectors along which the signal strength is maximized within the first and second windows, thereby determining the first and second vectors, respectively.

22. A cross polarization system for facilitating receipt of a desired signal by an antenna, the cross polarization system comprising:
a window acquisition module configured to establish a first window and a second window, with respect to the antenna; and
a tuning module configured to determine a first vector within the first window, the first vector corresponding to communication of the antenna with a first transmitter, and a second vector within the second window, the second vector corresponding to communication of the antenna with a second transmitter, to facilitate determination of a skew angle at which the antenna is disposable to cross polarize the antenna with respect to the desired signal

23. The cross polarization system of claim 22, wherein the tuning module receives the first and second windows and initiates motion of the antenna to receive signals from within the first and second windows, wherein the tuning module receives signal strength data from within the first and second windows to find vectors along which the signal strength is maximized within the first and second windows, thereby determining the first and second vectors, respectively.

24. The cross polarization system of claim 23, further comprising a vector manipulation module configured to mathematically process the first and second vectors to obtain a third vector extending between the first and second transmitters, wherein the skew angle is derived from the third vector.

25. The cross polarization system of claim 23, wherein the tuning module is configured to communicate with the motor controller to pivot the antenna about the elevation and azimuth axes to obtain the first vector, and then exclusively about the skew axis to simultaneously obtain the second vector and dispose the antenna at the skew angle.

26. A method for receiving a desired signal via an antenna, the method comprising:
aligning the antenna to receive a first signal from a first transmitter;
aligning the antenna to receive a second signal from a second transmitter; and
receiving the desired signal with the antenna disposed at a skew angle obtained via alignment of the antenna with the first and second transmitters.

27. The method of claim 26, wherein aligning the antenna to receive the first signal comprises pivoting the antenna about an elevation axis and an azimuth axis to orient the antenna to communicate with the first transmitter, the method further comprising pivoting the antenna about a skew axis to dispose the antenna at the skew angle prior to reception of the desired signal with the antenna disposed at the skew angle.

28. The method of claim 26, wherein the antenna is shaped to reflect the first signal from the first transmitter, wherein aligning the antenna to receive the first signal comprises receiving the first signal with a first LNB after reflection of the first signal from the antenna.

29. The method of claim 28, further comprising:
obtaining a first vector corresponding to communication of the antenna with the first transmitter;
obtaining a second vector corresponding to communication of the antenna with the second transmitter;
mathematically processing the first and second vectors to obtain a third vector extending between the first and second transmitters; and
deriving the skew angle from the third vector.

30. The method of claim 29, wherein the desired signal is to be received from the first transmitter, the first transmitter comprising a first dish, the method further comprising offsetting the third vector to provide the skew angle such that, when the antenna is disposed at the skew angle, the antenna is substantially parallel to the first dish.

31. The method of claim 28, wherein aligning the antenna to receive the second signal comprises receiving the second signal with a second LNB after reflection of the second signal from the antenna, wherein the first and second LNB's are relatively disposed such that the antenna is able to simultaneously receive the first and second signals via the first and second LNB's, respectively.

32. The method of claim 31, wherein aligning the antenna to receive the first signal comprises pivoting the antenna about the elevation and azimuth axes to obtain the first vector, wherein aligning the antenna to receive the second signal comprises pivoting the antenna exclusively about the skew axis to simultaneously obtain the second vector and dispose the antenna at the skew angle.

33. The method of claim 26, wherein aligning the antenna to receive the first signal comprises receiving location and orientation data from a sensor array coupled to the antenna and utilizing the location and orientation data to obtain a first window, within which the first vector is disposed, and wherein aligning the antenna to receive the second signal comprises utilizing the location and orientation data to obtain a second window, within which the second vector is disposed.

34. The method of claim 33, wherein aligning the antenna to receive the first signal comprises moving the antenna to receive the first signal from within the first window, and receiving signal strength data from within the first window to find a vector within the first window along which signal strength is maximized, thereby determining the first vector, wherein aligning the antenna to receive the second signal comprises moving the antenna to receive the second signal from within the second window and receiving signal strength data from within the second window to find a vector within the second window along which signal strength is maximized, thereby determining the second vector.

35. The method of claim 26, wherein the first transmitter comprises a first satellite comprising a first dish and the second transmitter comprises a second satellite comprising a second dish, wherein aligning the antenna to receive the first signal comprises orienting the antenna substantially parallel to the first dish to enable communication of the antenna with the first satellite, wherein aligning the antenna to receive the second signal comprises orienting the antenna substantially parallel to the second dish to enable communication of the antenna with the second satellite.

36. The method of claim 35, wherein the second satellite is displaced from the first satellite by at least fifteen degrees with respect to the antenna.

37. A method for cross polarizing a desired signal with an antenna, the method comprising:
determining a first vector corresponding to communication of the antenna with a first transmitter;
determining a second vector corresponding to communication of the antenna with a second transmitter; and
obtaining a skew angle for the antenna based on the first and second vectors.

38. The method of claim 37, wherein the first transmitter comprises a first satellite comprising a first dish and the second transmitter comprises a second satellite comprising a second dish, wherein determining the first vector comprises orienting the antenna substantially parallel to the first dish to permit communication of the antenna with the first satellite, wherein determining the second vector comprises orienting the antenna substantially parallel to the second dish to permit communication of the antenna with the second satellite.

39. The method of claim 38, wherein obtaining the skew angle for the antenna comprises determining a third vector extending between the first and second satellites.

40. The method of claim 39, wherein the desired signal is to be received from the first satellite, wherein obtaining the skew angle for the antenna comprises offsetting the third vector to provide the skew angle such that, when the antenna is disposed at the skew angle, the antenna is substantially parallel to the first dish.

41. The method of claim 39, wherein the desired signal is to be received from a third satellite disposed generally midway between the first and second satellites such that the third vector provides the skew angle substantially without adjustment.

42. The method of claim 37, further comprising:
receiving location and orientation data from a sensor array coupled to the antenna; and
utilizing the location and orientation data to obtain a first window, within which the first vector is disposed, and a second window, within which the second vector is disposed;
wherein determining the first vector comprises receiving the first window, moving the antenna to receive a first signal from within the first window, and receiving signal strength data from within the first window to find a vector along which signal strength is maximized within the first window to determine the first vector;
wherein determining the second vector comprises receiving the second window, moving the antenna to receive a second signal from within the second window, and receiving signal strength data from within the second window to find a vector along which signal strength is maximized within the second window to determine the second vector.

43. A method for cross polarizing a desired signal with an antenna, the method comprising:
establishing a first window with respect to the antenna;
determining a first vector within the first window, the first vector corresponding to communication of the antenna with a first transmitter;
establishing a second window with respect to the antenna; and
determining a second vector within the second window, the second vector corresponding to communication of the antenna with a second transmitter, to obtain a skew angle at which the antenna is disposable to cross polarize the antenna with respect to the desired signal.

44. The method of claim 43, wherein determining the first vector comprises receiving the first window, initiating motion of the antenna to receive a first signal from within the first window, and receiving signal strength data from within the first window to find a vector along which the signal strength is maximized within the first window, wherein determining the second vector comprises receiving the second window, initiating motion of the antenna to receive the second signal from within the second window, and receiving signal strength data from within the second window

45. The method of claim 44, further comprising:
mathematically processing the first and second vectors to obtain a third vector extending between the first and second transmitters; and
deriving the skew angle from the third vector.

46. The method of claim 44, wherein determining the first vector comprises pivoting the antenna about elevation and azimuth axes to obtain the first vector, wherein determining the second vector comprises pivoting the antenna exclusively about a skew axis to simultaneously obtain the second vector and dispose the antenna at the skew angle.

47. A computer readable medium comprising computer code for facilitating receipt of a desired signal by an antenna, wherein the computer code is configured to carry out a method comprising:
initiating alignment of the antenna to receive a first signal from a first transmitter;
initiating alignment of the antenna to receive a second signal from a second transmitter; and
receiving the desired signal with the antenna disposed at a skew angle obtained via alignment of the antenna with the first and second transmitters.

48. The computer readable medium of claim 47, wherein the antenna is shaped to reflect the first signal from the first transmitter, wherein aligning the antenna to receive the first signal comprises receiving the first signal with a first LNB after reflection of the first signal from the antenna.

49. The computer readable medium of claim 48, further comprising:
obtaining a first vector corresponding to communication of the antenna with the first transmitter;
obtaining a second vector corresponding to communication of the antenna with the second transmitter;
mathematically processing the first and second vectors to obtain a third vector extending between the first and second transmitters; and
deriving the skew angle from the third vector.

50. The computer readable medium of claim 48, wherein aligning the antenna to receive the second signal comprises receiving the second signal with a second LNB after reflection of the second signal from the antenna, wherein the first and second LNB's are relatively disposed such that the antenna is able to simultaneously receive the first and second signals via the first and second LNB's, respectively.

51. The computer readable medium of claim 50, wherein aligning the antenna to receive the first signal comprises pivoting the antenna about the elevation and azimuth axes to obtain the first vector, wherein aligning the antenna to receive the second signal comprises pivoting the antenna exclusively about the skew axis to simultaneously obtain the second vector and dispose the antenna at the skew angle.

52. The computer readable medium of claim 47, wherein aligning the antenna to receive the first signal comprises receiving location and orientation data from a sensor array coupled to the antenna and utilizing the location and orientation data to obtain a first window, within which the first vector is disposed, and wherein aligning the antenna to receive the second signal comprises utilizing the location and orientation data to obtain a second window, within which the second vector is disposed.

53. The computer readable medium of claim 52, wherein aligning the antenna to receive the first signal comprises moving the antenna to receive the first signal from within the first window, and receiving signal strength data from within the first window to find a vector within the first window along which signal strength is maximized, thereby determining the first vector, wherein aligning the antenna to receive the second signal comprises moving the antenna to receive the second signal from within the second window and receiving signal strength data from within the second window to find a vector within the second window along which signal strength is maximized, thereby determining the second vector.

54. The computer readable medium of claim 47, wherein the first transmitter comprises a first satellite comprising a first dish and the second transmitter comprises a second satellite comprising a second dish, wherein aligning the antenna to receive the first signal comprises orienting the antenna substantially parallel to the first dish to enable communication of the antenna with the first satellite, wherein aligning the antenna to receive the second signal comprises orienting the antenna substantially parallel to the second dish to enable communication of the antenna with the second satellite.
